(19) United States
(12) Patent Application Publication
(10) Pub. No.: US 2007/0112575 A1
(43) Pub. Date: May 17, 2007

(54) System and method for configuring a state of an internet protocol television network

(75) Inventors: Raghvendra G. Savoor, Walnut Creek, CA (US); Canhui Ou, Danville, CA (US); Zhi Li, San Ramon, CA (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/280,065

(22) Filed: Nov. 16, 2005

(51) Int. Cl. G06Q 99/00

(52) U.S. Cl. 705/1

(57) ABSTRACT

A system for configuring an IPTV network is provided. The system includes a computer program accessible to a video server that includes instructions to configure the network to a first state, collect subscriber data for a plurality of geographical regions, correlate the subscriber data to available channels, compute video server and transport costs, and configure the network to a second state to provide video servers in one or more of the geographical regions.

### BACKGROUND OF THE DISCLOSURE

1. Field of the Disclosure

The present disclosure relates to the field of internet protocol-based television (IPTV) networks.

2. Background

In an internet protocol television (IPTV) network, a very large number of channels/programming is available for provisioning to subscribers. Many such channels are of special, local or regional interest. Servers placed at various levels (national, regional, local, etc.) can provide the available channels to the various geographical regions served by the network. Costs for servers and costs to transport the channels (video and voice) can vary depending upon the size and location of the servers. Thus, there is a need to configure the IPTV networks that can efficiently and cost effectively distribute the available channels to the various regions.

### BRIEF DESCRIPTION OF THE DRAWINGS

For detailed understanding of the present disclosure, references should be made to the following detailed description of an exemplary embodiment, taken in conjunction with the accompanying drawings, in which like elements have been given like numerals.

FIG. 1 is a schematic diagram depicting an IPTV network employing multiple geographic regions in accordance with an embodiment of the present disclosure;

FIG. 2 is a schematic diagram illustrating multiple geographic server regions for placement of servers according to an embodiment of present disclosure;

FIG. 3 is a diagram illustrating configuring an initial state for an IPTV network;

FIG. 4 is a diagram illustrating collecting subscriber activity data collection from the IPTV network;

FIG. 5 is a diagram illustrating testing of decision variables for placing a server in a geographic location in the IPTV network;

FIG. 6 is a diagram illustrating calculating a cost for video acquisition and redistribution for video server geographic locations in the IPTV network;

FIG. 7 is a diagrammatic representation of a machine in the form of a computer system within which a set of instructions, when executed, may cause the machine to perform any one or more of the methodologies of the present disclosure; and

FIG. 8 is a diagrammatic representation of a data structure for representing an IPTV network state.

### DETAILED DESCRIPTION OF THE DISCLOSURE

Internet protocol television (IPTV) networks are internet protocol (IP) switched and can add content and transmission bandwidth downstream from a source between the source and a subscriber. Thus, special interest content can be added downstream from a source and redistributed in an IPTV network on a regional or local basis. The present disclosure enables IPTV providers to provide special interest local channels to selected geographic regions which are currently not provided by the incumbent cable television systems. Video servers can be added to an IPTV network in selected geographic locations to provide special interest channels to a geographic region.

There are tradeoffs, however, to be considered in video server placement in an IPTV network. A video server may be placed in the IPTV network close to a geographic region with a population of IPTV subscribers interested in a local or special interest channel or program. Candidate geographic regions for placing video servers in the IPTV network include national, regional, state, metro, city, and serving-area interfaces (SAI).

For example, a tradeoff that exists in placing a video server at different IPTV geographic regions can be demonstrated as follows. In placing a video server, a network provider will weigh the cost of a number of servers needed to provide service versus a desire to customize program content and advertising. If the video servers are placed in a geographic region closer to the IPTV subscribers such as at a metro or city geographic region level, the video servers can provide greater customization of content. Advertising may be targeted to the subscribers in that geographic region, but may require additional video servers and cost to purchase and maintain the additional video servers. If the video servers are placed farther away from the IPTV subscribers, such as at a national level, fewer servers are needed but less customization is possible. Moreover, transport cost is also a factor, as network transmission bandwidth and video server capacity may be wasted if a video server for a special interest channel is placed too far upstream (closer to the top hierarchical network level, i.e., the SHO) from a geographic locations. Bandwidth is wasted when not all special interest programming is of nationwide interest.

The present disclosure helps make decisions and weigh these tradeoffs for video server placement in an IPTV network. In the context of this document, video servers may include video-acquisition servers, video-distribution servers, video-on-demand (VoD) servers, and interactive advertising host servers. For purposes of this document all such servers will be collectively referred “video servers.” The present disclosure enables determining the efficient placement of such video servers in an IPTV network for content acquisition and delivery based on operational and transport cost. Operational cost includes, but is not limited to the cost of purchasing and maintaining a server at a particular geographic region in an IPTV network. Transport cost includes but is not limited to bandwidth utilized in providing a special interest channel to a particular geographic region in the IPTV network. The present disclosure enables determining the optimal distribution of local and special interest programming channels to subscribers in the IPTV network.

As an IPTV network adds more and more subscribers, subscriber density increases at the city and metro level of geographic regions in an IPTV network. As the subscriber density increases, the unit cost of serving and transporting content to a local geographic region (metropolitan, city) increases significantly for each incremental local or special interest programming channel added to the line up offered at the local geographic region. For example, if a community of interest for a particular sporting event is primarily a segment for the total population, the cost of adding a channel exclusively covering the particular sporting event at a national level (at a super hub office (SHO)) has high cost implications, since transport and capacity costs can be significant. Thus, if a local community of interest across multiple local and special interests can be effectively identified in a particular geographic region in an IPTV network, then local video servers placement in the particular geographic region can be justified. As local and national community of interest toward special interest or local programming content changes, IPTV network server locations and bandwidth allocations in the IPTV network can be moved to migrate the servers toward the most economic geographic region in the IPTV network.

To effectively provide video services, business rules or criteria are provided by the present disclosure to effectively locate the video servers in the IPTV network. These business rules may be applied to analyze the IPTV network, available channels, bandwidth, server cost, transmission cost, targeted advertising and subscriber activity in the IPTV network. The business rules configure the IPTV network state so that a service provider places the video servers in geographic regions according to the network state. Thus the present disclosure substantially minimizes the cost of video server placement and content acquisition and redistribution. Cost includes but is not limited to server cost, server operation expense for collocating video servers versus separately locating video servers, server maintenance and transport cost. Transport cost includes but is not limited to utilization and recovery of IPTV bandwidth based on video server placement. The configured IPTV network state enables the provision of more local and special interest programming and more effective targeting of advertising. The present disclosure determines how the video servers in the IPTV network should be sized regarding processor speed and memory size. The present disclosure determines geographic regions in the IPTV network relative to the geographic regions for subscribers where each national and special interest programming channel or content be acquired and redistributed to subscribers. These determinations may be largely based on trends for the subscriber activity and demographics of subscribers in the geographical regions within an IPTV network. The subscribers in a geographic region may also be characterized by subscriber activity data (sports fan, game player, TV viewing patterns, programming selections, consumer activity, etc.) and subscriber demographics (e.g. Spanish speaking, French speaking, New York Yankee regional fans, etc.).

Subscriber activity data is used to configure the IPTV network. It is expected that tens of millions of IPTV subscriber households will be added to the IPTV networks in the United States over the next decade. Fortunately, IPTV technology offers new alternatives to gather subscriber activity data to automatically track which TV programs, content usage and other IPTV services that are being used at an IPTV subscriber location. Servers within an IPTV network in which IPTV systems are provided can monitor content that is delivered to set top boxes (STBs) in homes and businesses. The STBs may include computer processors or other intelligent devices, are generally connected to television sets or computer monitors, where the broadcast content is displayed. The granularity of the monitoring enables determination of subscriber activity and demographics (based on activity or subscriber account information) down to a sub user account in a household. Subscriber activity data can be aggregated on any level above a subscriber account sub user, for example, by ZIP code.

The present disclosure provides a subscriber activity data monitoring system that aggregates and analyses the subscriber activity data from individual IPTV geographic region subscribers in an IPTV network. Business rules are applied to the subscriber account data to make decisions regarding the configuration of the IPTV network based on the subscriber activity data. The IPTV network is configured for efficient acquisition and redistribution of content and advertising to subscribers within a geographic region.

The present disclosure provides a system and method for efficiently configuring a physical IPTV network based on cost. The resulting physical IPTV network can be represented in a data structure defining an IPTV network state (configuration of network nodes; server sizing, server locations in geographic regions and sizing of communication link bandwidth between the nodes). The disclosure efficiently configures the IPTV network state to locate and specify the speed and size of video servers in geographic regions in the IPTV network. The IPTV network state represents a network configuration that has been efficiently configured to place and size video servers in the IPTV network. The video servers are placed to efficiently acquire and redistribute national and special interest video programming and content over a switched IPTV network. Placement of the servers is based on available channels, bandwidth, existing network topology, subscriber activity and demand for IPTV services. The present disclosure provides a cost-effective approach to enable acquisition and proliferation of local and special interest programming. The present disclosure provides business rules to analyze IPTV subscriber activity, subscriber interest, subscriber demographics, IPTV network transport cost, server cost, and incremental network revenue and expenses to determine efficient location of video servers in the IPTV network. Efficient IPTV network configuration helps to lower unit video server and transport costs while improving performance metrics for video services provided by the IPTV network.

The present disclosure enables strategic placement of video-related servers in strategic locations in IPTV geographic regions to minimize overall network and unit transport and cost and increase bandwidth utilization and efficiency. The present disclosure provides a network state that that provides increased network quality of service for ITPV services delivery in an IPTV network. The increased quality of service reduces jitter and latency, and increases content availability and packet delivery rate. The present disclosure enhances a service provider's ability to provide greater customization and targeting of local and special interest programming for more effective targeting of sponsored commercial messages or advertising.

In one aspect of the disclosure, a method is provided for configuring an IPTV network in which a first state for the IPTV network is configured, having one or more geographic regions. The method provides for collecting subscriber activity from one or more geographic regions in the first state of the IPTV network. The method correlates characteristics of one or more available channels with characteristics for each of the geographic regions. The method provides for calculating a cost of placement of a video server in each of the geographical regions for providing the one or more available channels to each geographic region. The method then configures the IPTV network first state to a second state having a server in a geographical region selected from the geographic regions based on cost. The method is iterative so that subsequent network states are also configured based on additional subscriber activity data.

In another aspect of the disclosure, a system is provided that contains a network database for storing an IPTV network state, an IPTV subscriber activity data base storing subscriber activity data for the IPTV network and a processor. A computer readable medium is provided and is accessible to the processor. A computer program is embedded within the computer readable medium. The computer program contains instructions to collect the subscriber activity data from a set of geographic regions in the first state of the IPTV network, instructions to compare or correlate characteristics of available channels with each of the of the geographic regions and instructions to calculate a cost for placement of a video server in each of the geographic regions for providing the available channels. The computer program also contains instructions to configure the IPTV network first state to a second state having a video server in a video geographic region selected from the plurality of geographic regions based on cost.

In another aspect of the disclosure, an IPTV network is provided containing a group of IPTV geographic regions and a set of high speed digital communication links connecting the plurality of IPTV geographic regions. A set of video servers is placed in a selected geographic region of the group of IPTV geographic regions. The video servers are placed in a selected geographic region in the subset based on a computer program. The computer program contains instructions to collect the subscriber activity data from a group of geographic regions in the initial state of the IPTV network and instructions to correlate or compare characteristics of available channels with characteristics for each of the group of geographic regions. The computer program also contains instructions to calculate a cost for placement of a video server in each of the group of server locations for providing the available channels correlated to each geographic region and instructions to configure the IPTV network firs state to a secondary state having a server in a geographic region selected from the group of geographic regions based on cost.

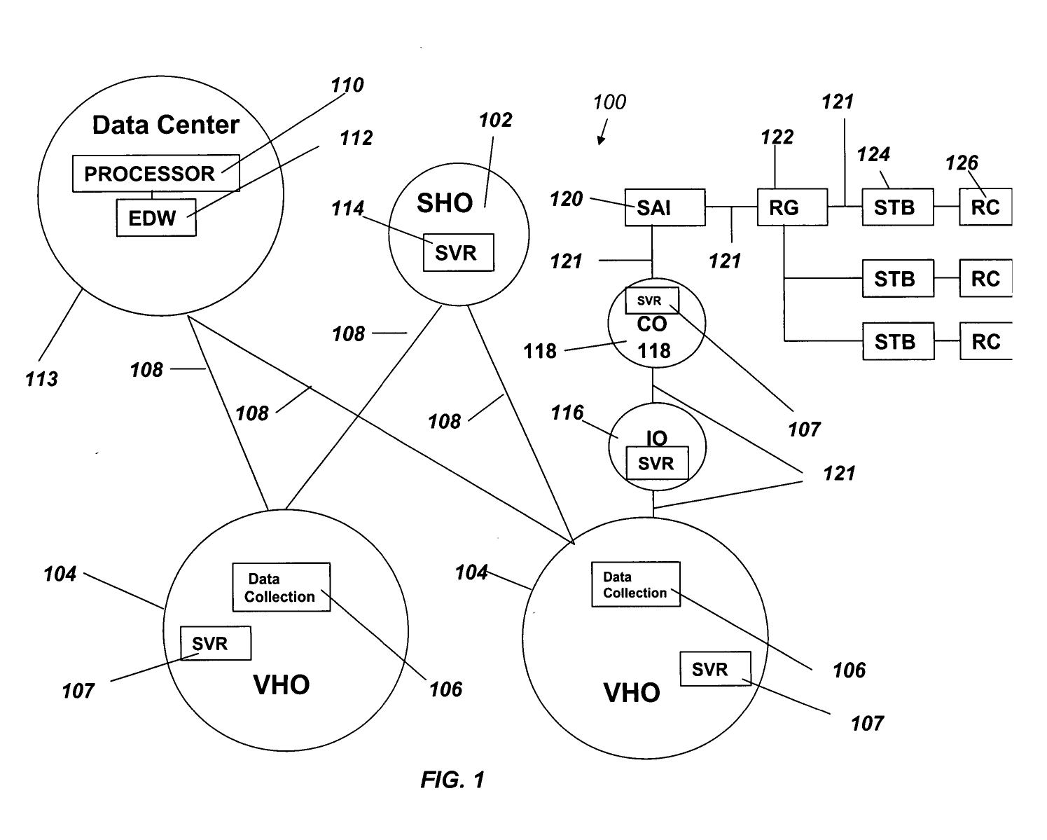

FIG. 1 is a schematic diagram depicting a physical IPTV network employing multiple geographic regions in accordance with an embodiment of the disclosure. As shown in FIG. 1, the communication network 100 includes major elements: a Super hub office (SHO) 102 for acquisition and encoding of video content; Video hub office (VHO) 104 in each demographic market area (DMA); Intermediate offices (IO) 116 and Central offices (CO) 118 locations in each metropolitan area; the access network (SAI) between the central offices and multiple or single dwelling units; and the in-home network with residential gateway (RG) 122. The SHO, VHO, IO and CO are located in separate geographic regions (nation, region, state, metropolitan, city and service area interface (SAI)) to communicate to subscribers over high speed digital communication lines 108.

An initial IPTV network state is configured and stored in the electronic data warehouse (EDW) 112. The initial IPTV network state can be implemented and realized as an actual deployed physical IPTV network 100 as shown in FIG. 1. In the initial IPTV network state, a server 114 placed at the SHO 102 acquires and redistributes content to the VHOs 104 which may be spread across a large geographic region such as a country, such as the United States, England or France. In an initial IPTV network state, the SHO may be provided in a geographically central location for acquisition of national-level broadcast TV (or linear) programming. Initially, the SHO can also be the central point of on-demand content acquisition and insertion of content into the IPTV network. Linear programming can be received at the SHO 102 via satellite and processed for delivery to the VHOs 104. On demand content is received from various sources and processed for code/decode and bit-rate requirements for the IPTV network for transmission to the VHOs over high speed communication links 108.

The VHOs 104 can receive national content from the SHO 102 video server 114. The VHOs are the video redistribution points within each designated market area (DMA) or geographic region. Initially application systems, regional subscriber database systems, VOD servers, and fast channel-change servers can be located in the VHO. In the present example of the disclosure, at least one IPTV data collection processor 106 is placed at each VHO. The IPTV data collection processor 106 includes memory and input/output. Thus, IPTV subscriber activity data can be collected at the IPTV data collection processor 106 from all subscribers associated with a particular VHO and sent to an electronic data warehouse (EDW) 112 for analysis. In an initial network state, a single server 114 can be placed at the SHO. Content from SHO server 114 is redistributed to the VHOs 104 toward the subscriber via the intermediate offices (IOs) 116 and the central offices (COs) 118. The COs are connected to the IOs to further distribute video content toward the subscribers. As the IPTV network state is reconfigured, additional proposed servers 107 can be placed in geographic regions containing the SHO, VHO, IO and CO in the IPTV network.

Traffic reaches the subscribers residential gateway (RG) 122 at least partially via either fiber to the node (FTTN) or fiber to the premises (FTTP). FTTN equipment, located at a serving area interface (SAI), can be connected to the CO. FTTN equipment may also be located in the CO. Toward the subscriber household, a network interface device (NID) and RG 122 with a built-in VDSL modem or optical network termination (ONT) comprise the customer premise equipment (CPE). In both cases the RG is connected to the rest of the home STBs 124 via an internal network such as an Ethernet. Each STB has an associated remote control (RC) 126 which provides data entry to the STB to control the IPTV selections from the IPTV system.

Subscriber activity data comprising IPTV channel selection, control inputs and data entry is collected from each STB in a household. The subscriber activity data may be collected and transmitted from the RG to an IPTV data collection processor 106. An IPTV data collection processor 106 runs in each VHO. The IPTV data collection processor 106 may be a Sun Microsystems processor with memory and input/output. The subscriber activity data is collected periodically at IPTV data collection processor 106 or in real-time from each RG and transmitted to the electronic data warehouse (EDW) 112. In the current example of the disclosure, the IPTV data collection processors 106 transmit the subscriber activity data to the EDW 112 in a secure Data Center 113. The Data Center 113 is an internal location within a secured firewall. EDW 112 may be a commercial database such as provided by Oracle running on a Sun Microsystems processor. Other processors and database systems are suitable for use with the present disclosure as well.

The EDW comprises a processor and data storage medium that provides mass storage and business rules for analysis of the subscriber activity data. A data collection application processor 114 associated with EDW runs in a processor at the Data Center. Processor 110 applies the business rules stored in the EDW to the subscriber activity data stored in the EDW. The present disclosure periodically collects the subscriber activity data from each VHO. The present disclosure may also operate in real time to collect the data from the VHOs. The subscriber activity data from each VHO is pulled by the present disclosure periodically or can be collected in real time and relayed to the EDW. Real time data collection enables real time data analysis for iterative configuration of the IPTV network and dynamic management of content and advertising distribution at the VHO.

The STB 124 may forward the subscriber activity data to the RG which in turn sends the subscriber activity data to IPTV data collection processor 106 via a communication path 121 between the VHO and the associated RG. Substantially all consumer activity data including but not limited to remote control activity is recorded as subscriber activity data at the IPTV data collection processors 106 and sent to the EDW 112. The SHO processor 110 may be implemented as a Sun Microsystems processor. The STB can contain a single microprocessor and memory, or may be implemented as multiple microprocessors and memories located at a single location or at several locations. A downstream signal from the IPTV network to the display device includes content for display on the display device, and an upstream signal from the display device to the IPTV network instance. (via the remote control) includes subscriber activity data comprising channel selections and any other input from the RC.

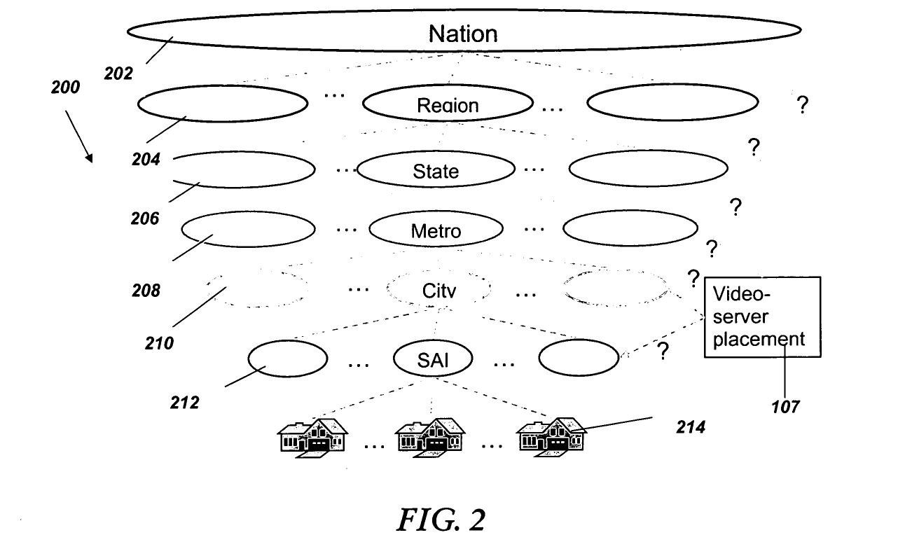

FIG. 2 is a schematic diagram illustrating multiple IPTV network geographic regions according to an embodiment of present disclosure. In the present example of the disclosure, the IPTV network geographic regions comprise National 202, regional 204, state 206, metropolitan 208, city 210 and service area interface (SAI) 212. The IPTV network delivers video to the household 214 from one or more of the geographic regions national 202, regional 204, state 206, metropolitan 208, city 210 and service area interface (SAI) 212. A video server may be placed in each geographic region in the IPTV network.

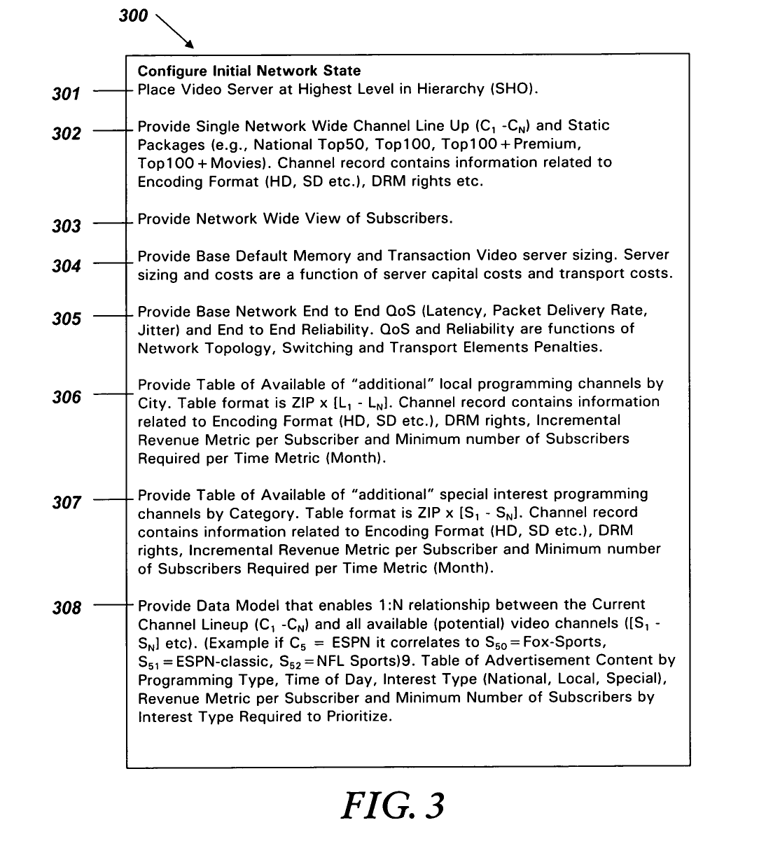

FIG. 3 is a diagram illustrating configuration of an initial IPTV network state. Turning now to FIG. 3, as shown at 300, the initial IPTV network state is described in which an IPTV network data structure in the memory at the EDW represents an initial IPTV network state. The data structure contains fields that represent IPTV geographic locations and placement of servers in the geographic locations. This initial network state is the initial network state prior to analysis and optimization or reconfiguration by the present disclosure to provide efficient server placement and content acquisition and distribution in the IPTV network. As shown at 301, in the initial IPTV network configuration, the video server 114 is placed at the highest level in IPTV network hierarchy, that is, at the SHO 102. As shown at 302 in the initial state a single network wide channel line up is provided (Channel₁-Channel_{N}) along with basic tier static packages (e.g., National Top50, Top100, Top100+Premium, Top100+Movies). Channel records for each channel are provided containing information related to Encoding Format (HD, SD etc.), DRM rights, interest, etc.

As shown at 303, the IPTV network state is stored in an IPTV network state data structure in an associated data base at the EDW also which provides a network wide view of subscribers. Business rules are also stored in the EDW for analyzing and correlating the channels demand, regional interest and other attributes with the demographics and subscriber activity in each particular geographic region associated with the IPTV network.

As shown at 304, the initial IPTV network state in the data structure provides a base default memory and transaction video server sizing. Server sizing (processor speed and associated memory) and costs (associated with processor speed, associated memory and operational cost associated with facility location) are provided as a function of server capital costs and transport costs. The transport cost is associated with the provision of bandwidth associated with high speed communication link cost, for example, fiber optic transmission line costs or other transport mechanism costs. As shown at 305 the initial network configuration also provides a base network for estimating end to end IPTV network quality of service (QoS) (latency, packet delivery rate, jitter) and end to end IPTV network reliability. QoS and reliability are functions of network topology, switching and transport elements penalties in the IPTV network.

As shown at 306, the EDW data base stores a table of available of “additional” local and special interest programming channels by geographic region, organized, for example, by U.S. postal ZIP code. The table format for local and special interest programming channels can comprise a list of local channels available in each ZIP Code. The table can also include channel record information related to the local channel attributes, such as for example: Encoding Format (HD, SD etc.), DRM rights, Incremental Revenue Metric per Subscriber and Minimum number of Subscribers Required per Time Metric (Month). Each local and special interest channel is characterized by demographic interest (i.e., the Spanish channel appeals to regions with Spanish speaking population) and regional interest (i.e., regions proximate to a particular college are more interested in the broadcast of that particular college's football game).

As shown at 307, the EDW data base also provides a Table of Available “additional” special interest programming channels by category. Categories may consist of but are not limited to sports, Spanish, local interest topic, geographic region of interest, etc. Similar to the table for local channels, the table format can be organized as a list of special interest channels available in each ZIP code. The table includes attributes for special interest channel related to encoding format (HS, SD, etc.), DRM rights, incremental revenue metric per subscriber and minimum number of subscribers required per time metric (month) to add a channel.

As shown at 308, a data model is provided that enables 1:N relationship between the current channel lineup (C₁-C_{N}) and all available (potential) video channels ([S₁-S_{N}] etc). (Example if C₅=ESPN it correlates to S₅₀=Fox-Sports, S₅₁=ESPN-classic, S₅₂=NFL Sports). A table of advertisement content by programming type, time of day, interest type (national, local, special), revenue metric per subscriber and minimum number of subscribers by interest type used to prioritize.

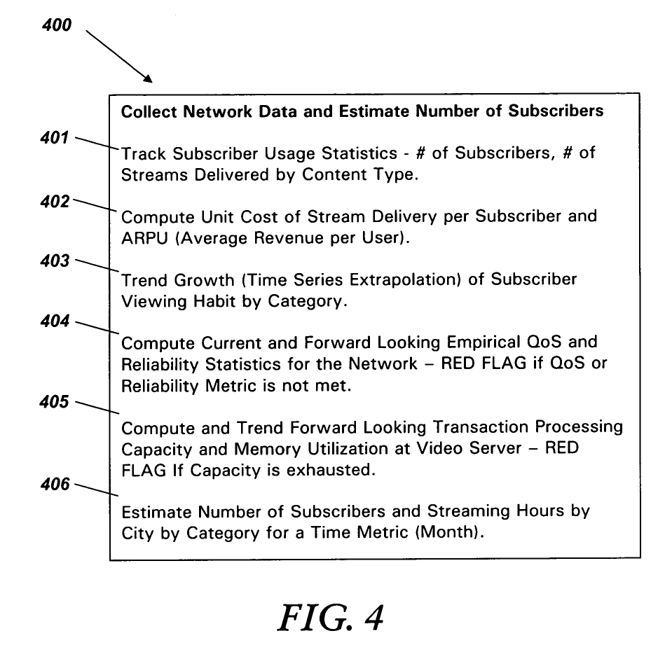

FIG. 4 is a diagram illustrating collecting subscriber activity data collection from the IPTV network. Turning now to FIG. 4, after the initial physical IPTV network configuration is operational, the IPTV network subscriber activity data is collected as shown at 400. As shown at 401, the present disclosure tracks subscriber usage statistics, subscriber activity data, number of subscribers and number of streams delivered by content type. The present disclosure then computes the unit cost of stream delivery per subscriber (cost of stream, e.g. ESPN contract price divided by number of subscribers) and ARPU (average revenue per user, amount paid to view ESPN by each subscriber) as shown at 402. The present disclosure determines trend growth (time series extrapolation) of subscriber viewing activity habits by category as shown at 405. The present disclosure then computes current and forward looking empirical quality of service (QoS) and reliability statistics for the IPTV network and issues an alert if a predetermined QoS or Reliability Metric is not met as shown at 404. The present disclosure then computes and trends forward looking transaction processing capacity (transport bandwidth) and memory utilization at the video server and generates a warning if the capacity (transport bandwidth) is exhausted as shown at 405. The present disclosure then estimates the number of subscribers and streaming hours by geographic region (city, metropolitan, etc.) by category for a time metric (month) as shown at 406.

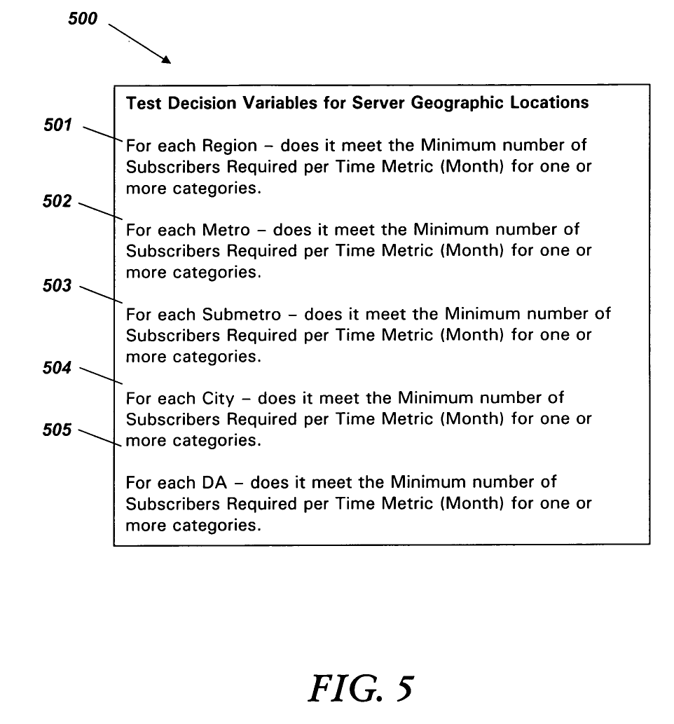

FIG. 5 is a diagram 500 illustrating testing of decision variables for placing a server in a geographic region in the IPTV network. Turning now to FIG. 5, the present disclosure analyzes subscriber activity data collected from the IPTV network. The present disclosure determines for each geographic region whether the geographic region meets the minimum number of subscribers required per time metric (month) for one or more categories as shown at 501. For example, an IPTV provider may set a minimum number of potential viewers at 5,000 viewers to consider adding a new local or special interest channel to a geographic region. Each geographic region is examined to determine if a minimum number of subscribers exist. The present disclosure determines for each metro geographic region if it meets the minimum number of subscribers required per time metric (month) for one or more categories as shown at 502. The present disclosure determines for each submetro geographic region whether it meets the minimum number of subscribers required per time metric (month) for one or more categories as shown at 503. The present disclosure determines for each city geographic region, whether it meets the minimum number of subscribers required per time metric (month) for one or more categories as shown at 504. The present disclosure determines for each demographic area (DA) geographic region whether it meets the minimum number of subscribers required per time metric (month) for one or more categories as shown at 505.

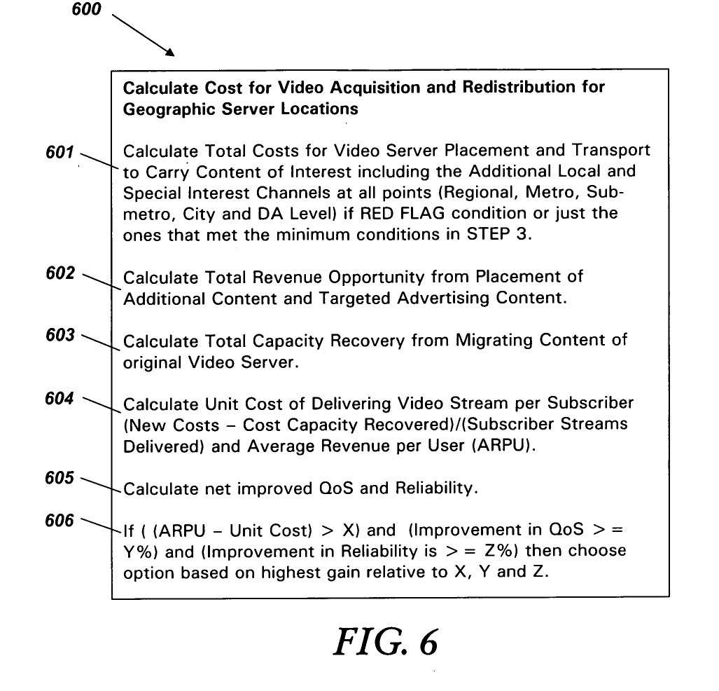

FIG. 6 is a diagram 600 illustrating calculating a cost for video acquisition and redistribution for geographic regions in the IPTV network. Turning now to FIG. 6, the present disclosure analyzes the geographic regions to make decisions for substantially efficient placement of video servers in the IPTV network geographic regions, thereby selecting a substantially efficient IPTV server location or tail end location for video acquisition. The present disclosure calculates total costs for video server placement and transport to carry content of interest including the additional local and special interest channels in each geographic region (regional, metro, sub-metro, city and DA level) as shown at 601. A substantially efficient geographic region is selected for placement of the video server based on cost.

The present disclosure then calculates total revenue opportunity (additional new channel fee per subscriber times number of projected new channel subscribers) from placement of additional content and targeted advertising content for each geographic region as shown at 602. The present disclosure calculates total bandwidth capacity recovery from migrating content of original video server in each geographic region as shown at 603. Capacity recovery occurs when bandwidth allocation is moved downstream toward a subscriber away from the SHO freeing up bandwidth for other uses. The present disclosure calculates unit cost of delivering video stream per subscriber (new costs−cost capacity recovered)/(subscriber streams delivered) and average revenue per user (ARPU). The present disclosure then calculates net improved QoS and reliability for the reconfigured IPTV network as shown at 605.

The present disclosure then applies a business rule or a set criteria (retrieved from the EDW) to determine efficient server placement. If ( (ARPU−Unit Cost)>X) and (Improvement in QoS>=Y %) and (Improvement in Reliability is>=Z %), the business rule then chooses a new geographic region based on highest gain relative to X, Y and Z as shown at 606. For example, X may be set at 20%, Y and Z may be set at 10%. The weights of X, Y and Z can be relatively weighted in this decision, for example, as multiplied by a weighting factor of 10, 2 and 2 respectively.

Prior to service launch of the physical IPTV network a demand forecast may include number of subscribers at each SAI and nation wide estimates of house holds interest per video bundle (or national channel). Unit costs for hosting, distributing and transporting content per video stream and capital costs for video servers and associated transport should be maintained. Once in service, empirical data or statistics on distribution of TV viewership for the IPTV network by household and VoD take rate by channel content category can be maintained at a local level and then aggregated to the appropriate next higher level geographic region for critical mass sensitivity. For example, a critical mass of 5,000 subscribers may be set to add a new channel at the geographic region level reaching 5,000 subscribers. Performance requirements and empirical performance statistics are compiled to support stringent service-level agreements (SLA) with the content providers including constraints on delay, jitter, packet loss, and downtime per year.

The present disclosure iteratively and dynamically generates a substantially efficient configuration leading to an overall substantially minimum cost by analyzing all possible network configuration combinations that satisfy the demand and performance goals for the network according to the business rules. It is assumed for the initial network configuration, on the first day of IPTV network operation, all the channels will be provided at the nation geographic region level (SHO) due to lack of empirical local community of interest data. The present disclosure also correlates empirical usage data, trends the correlated data for marketing intelligence, and re-optimizes the network state by placing video servers based on the demand and projected future demand. This step will be iterative over time.

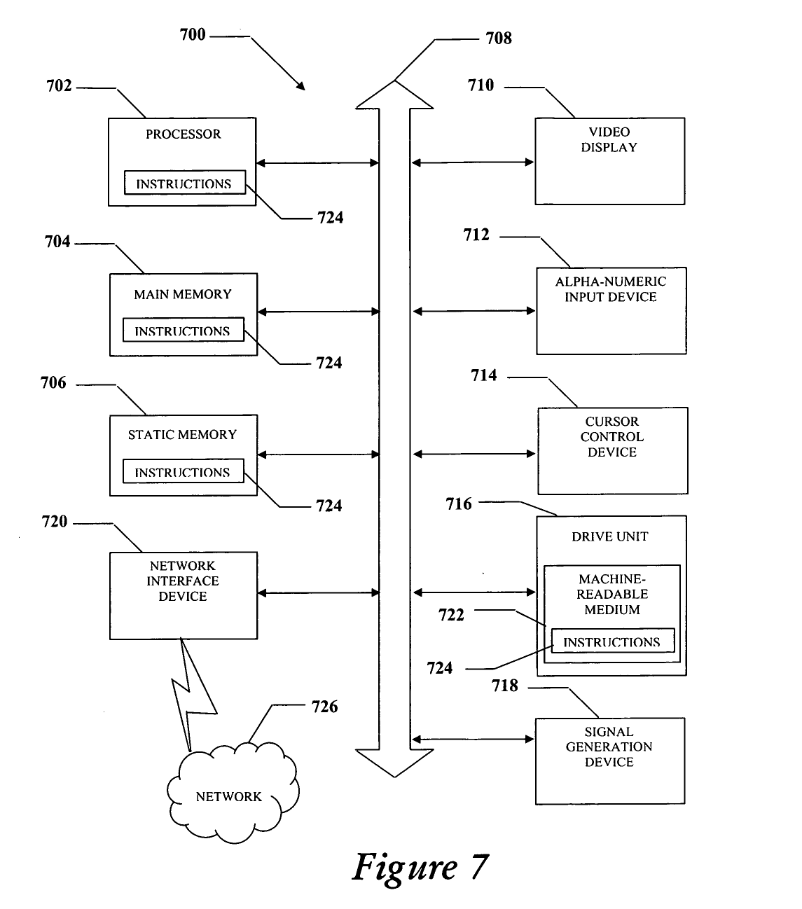

Turning now to FIG. 7, FIG. 7 is a diagrammatic representation of a machine in the form of a computer system 700 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated in herein above. The instructions 724 may also reside, completely or at least partially, within the main memory 704, the static memory 706, and/or within the processor 702 during execution thereof by the computer system 700. The main memory 704 and the processor 702 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

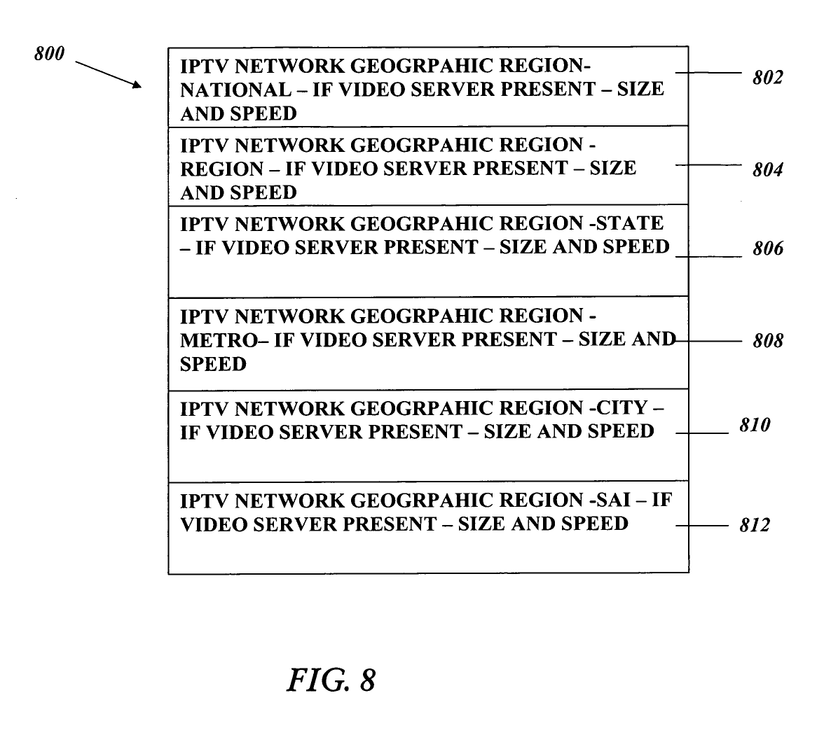

Turning now to FIG. 8, FIG. 8 illustrates a data structure 800 for representing the IPTV network state. A set of data structure fields is shown associated with the IPTV network geographic regions corresponding to the hierarchy of geographic regions: nation 802, region 804, state 806, metropolitan 808, city 810 and SAI 812 respectively. There can be multiple instances of each geographic region associated with a unique identifier in the data structure for uniquely representing multiple geographic regions in large area such as a nation. A video server 107 can be placed in any of the unique geographic regions. A video server 107, if present in one or more of the geographic regions is represented and specified as to server size and speed in the size and speed field in the data structure. A unique identifier for the server is stored in the Video Server Present field. If no video server is present in a particular geographic region, the video server present, size and speed fields for the particular geographic region are blank. The data structure fields for each geographic region include but are not limited to the following data structure fields: IPTV Network Geographic Location, Video Server Present, Video Server Size and Video Server Speed. The physical IPTV network is laid out according to the IPTV network state stored in the data structure 800. Additional fields can be added to represent additional IPTV network elements such as nodes, communication links and other information associated with specifying an IPTV network.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “disclosure” merely for convenience and without intending to voluntarily limit the scope of this application to any single disclosure or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather, the disclosure extends to all functionally equivalent structures, methods, and uses such as are within the scope of the appended claims.

In accordance with various embodiments of the present disclosure, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

What is claimed is:

1. A system, comprising:
a network database for storing a first state for an IPTV network and for storing subscriber activity data for the IPTV network;
a processor having access to the database;
a computer readable medium accessible to the processor; and
a computer program embedded within the computer readable medium, the computer program comprising:
instructions to collect the subscriber activity data from a plurality of geographic regions in a first state of the IPTV network;
instructions to correlate available channels with the subscriber activity data for each of the plurality of geographic regions;
instructions to determine a set criterion for placement of a video server in a geographic region related from the plurality of geographic regions for providing an available channel correlated to the subscriber activity data; and
instructions to configure the first state to a second state placing the video server in geographic the selected region based on the set criterion.

2. The system of claim 1, wherein the computer program further comprises:
instructions to calculate a revenue opportunity for the placement of the video server; and
instructions to configure the first state to the second state based on the revenue opportunity.

3. The system of claim 1, wherein the computer program further comprises:
instructions to calculate a quality of service for the placement of the video server; and instructions to configure the first state to a second state if the calculated quality of service meets a set level.

4. The system of claim 3, wherein the computer program further comprises:
instructions to calculate a reliability for the placement of the video server; and
instructions to configure the first state to the second state if the calculated reliability meets a set reliability level.

5. The system of claim 1, wherein the set criterion comprises a cost for the video server and cost for transporting a channel to the selected regions.

6. The system of claim 1, wherein the computer program further comprises:
instructions to characterize each of the plurality of geographic regions according to a regional interest and demographics; and
instructions to correlate the available channels with the regional interest and demographics.

7. The system of claim 6, wherein the instructions to correlate further comprise instructions to correlate targeted advertising with the plurality of geographic regions.

8. A method for configuring a state of an internet protocol television (IPTV) network, comprising:
configuring the IPTV network to a first state that provides a set of channels from available channels to a plurality of geographic regions;
estimating a demand for an additional channel from the available channels for a selected geographic region from the plurality of geographic regions;
determining costs relating placement of a video in the IPTV network and for transporting the additional channel to the selected region; and
configuring the IPTV network from the first state to a second state to provide the additional channel to the selected geographic region.

9. The method of claim 8, wherein configuring the IPTV network to the first state further comprises providing a first server that provides the set of channels.

10. The method of claim 8, wherein configuring the IPTV network to the first state further comprises configuring the IPTV network to provide the set of channels at a base quality of service.

11. The method of claim 10 wherein configuring the IPTV network to the second state to provide the additional channel at the base quality of service.

12. The method of claim 8 further comprising:
estimating a revenue opportunity associated with the estimated demand; and
configuring the IPTV network to the second state if the estimated revenue opportunity exceeds the costs.

13. The method of claim 8, wherein configuring the IPTV network to the second state further comprises providing a second server in the second state to provide the additional channel.

14. The method of claim 7, wherein configuring the IPTV network to the second state further comprises migrating a content relating to the additional channel from the first server to the second server.

15. A computer readable medium accessible to a processor, comprising:
a computer program embedded within the computer readable medium, the computer program comprising:
instructions to access a subscriber activity data from a database relating to a plurality of geographic regions in a first state of an IPTV network;
instructions to correlate available channels with the subscriber activity data for each of the plurality of geographic regions;
instructions to determine a set criterion for placement of a video server in a selected geographic region from the plurality of geographic regions for providing a channel from the available channels correlated to the subscriber activity data for the selected geographic region; and
instructions to configure the first state to a second state placing the video server in the selected geographic region based on the set criterion.

16. The computer readable medium of claim 15, wherein the computer program further comprises:
instructions to calculate a revenue opportunity for the placement of the video server; and
instructions to configure the first state to the second state based on the revenue opportunity.

17. The computer readable medium of claim 15, wherein the computer program further comprises:
instructions to calculate a quality of service for placement of the video server; and
instructions to configure the first state to the second state if the calculated quality of service meets a set level.

18. The computer readable medium of claim 17, wherein the computer program further comprises:
instructions to calculate a reliability for placement of the video server; and
instructions to configure the first state to the second state if the calculated reliability meets a set reliability level.

19. The computer readable medium of claim 15, wherein set criterion includes cost of the video server and cost to transport the available channel according to the second state of the IPTV network.

20. The computer readable medium of claim 15, wherein the computer program further comprises:
instructions to characterize each of the plurality of geographic regions according to regional interest and demographics; and
instructions to correlate the available channels with each of the geographic regions based on the regional interest and demographics.

21. The computer readable medium of claim 15, wherein the instructions to correlate available channels further comprise instructions to correlate targeted advertising with each of the plurality of geographic regions.

22. An IPTV network comprising:
a plurality of high speed digital communication links connecting a plurality of IPTV network geographic regions;
a plurality of video servers placed in a selected subset of the plurality of geographic regions wherein the video servers are placed based on a computer program, wherein the computer program comprises:
instructions to collect subscriber activity data from the plurality of geographic regions in a first state of the IPTV network;
instructions to correlate available channels with the subscriber activity data for each of the plurality of geographic regions;
instructions to determine a set criterion for placement of a video server in each of the plurality of geographic regions for providing an available channel correlated to the subscriber activity data for each of the plurality of geographic regions; and
instructions to configure the IPTV network first state to a second state having the video server in a geographic region selected from the plurality geographic regions based on the set criterion.

23. The network of claim 22, wherein the computer program further comprises:
instructions to calculate a revenue opportunity for the placement of the video server in and instructions to configure the IPTV network first state to the second state based on the calculated revenue opportunity.

24. The network of claim 22, wherein the computer program further comprises
instructions to calculate a quality of service for the placement of the video server and instructions to configure the IPTV network first state to the second state based on the calculated quality of service.

25. The network of claim 22, wherein the computer program further comprises
instructions to calculate a reliability for placement of the video server; and
instructions to configure the IPTV network first state to a second state based on the calculated reliability.

26. The network of claim 22, wherein the set criterion comprises a transport cost and video server cost.
